(19) United States
(12) Patent Application Publication
(10) Pub. No.: US 2009/0266967 A1
(43) Pub. Date: Oct. 29, 2009

(54) Open Frame Mounting Brackets

(76) Inventors: Dan Allen, Albuquerque, NM (US); Dong Ho Choi, Palo Alto, CA (US)

Correspondence Address: Roeder & Broder LLP, 5560 Chelsea Avenue, La Jolla, CA, 92037, US

(21) Appl. No.: 12/111,887

(22) Filed: Apr. 29, 2008

(51) Int. Cl. F16M 13/00

(52) U.S. Cl. 248/512

(57) ABSTRACT

A mounting assembly (18) for mounting an optical component (14) along an optical axis (22) to an apparatus frame (12) of a precision apparatus (10) includes a mounting bracket (20). The precision apparatus (10) includes a first alignment rod (316A), a second alignment rod (316B), and a third alignment rod (316C) that extend parallel to the optical axis (22). The mounting assembly (18) includes a mounting bracket (20) having (i) a first component mount (242) for retaining the optical component (14), (ii) a first rod aperture (234) that receives the first alignment rod (316A) and a first rod lock (236) that selectively locks the first alignment rod (316A) to the mounting bracket (20), (iii) a second rod aperture (238) that receives the second alignment rod (316B) and a second rod lock (240) that selectively locks the second alignment rod (316B) to the mounting bracket (20), and (iv) a third rod aperture (356) that receives the third alignment rod (316C) and a third rod lock (358) that selectively locks the third alignment rod (316C) to the mounting bracket (20). The rod apertures (234) (238) (356) are spaced apart in a fashion to form the corners of an obtuse triangle (364). With this design, the mounting bracket (20) securely retains the optical component (14) while providing unobstructed access to the optical axis (22) for the easy and at-will insertion and removal of the optical components (14). This allows for the relatively easy arrangement, assembly, modification, and/or repair of the precision apparatus (10).

### BACKGROUND

Optical instruments and assemblies such as microscopes, telescopes, lasers, and fiber optic coupling and launch applications require a means of assembling optics collinearly along a specified path and introducing bends in the path at locations of mirrors, prisms and beamsplitters.

Previously developed platforms for optical instruments and assemblies rely heavily on combinations of the following approaches to align optics: breadboards, dovetail or similar optical rails, lens tubes, and cage assemblies.

The breadboard, a planar array of tapped holes on a flat surface, allows for at-will positioning of optics in all three dimensions with appropriate mounts. Typically, users fix optics to posts or pedestals which are anchored to the breadboard via bases with thru holes or clamping forks. However, breadboards are bulky, heavy, and have a preferred mounting orientation (with the surface normal vertical). This discourages use in vertically oriented systems, such as microscopes. Further, flat surfaces and arrays of threaded holes must be individually machined from stock and are not ideal for small, mass produced, few optical path systems.

Dovetail rails and mating mounts offer the ability to align optics of a variety of shapes and sizes and insert and remove optics at will in terms of positioning and arrangement, as well as insert and remove diagnostic elements. However, the dovetail rail has a preferred mounting direction (horizontal), requires continuous support, and does not incorporate a simple means of redirecting a beam in the vertical plane.

Lens tubes can be threaded or joined to allow insertion of optics of different diameters at particular spacings. Unfortunately, lens tubes inhibit access to the optical path entirely, making lens tubes troublesome for prototype development and testing.

Cage assemblies consist of mounting brackets or frames supported by a set of collinear alignment rods. FIG. 1 P illustrates a front view of a prior art cage assembly 2P and two side views of alternative cage assemblies 2P. In this embodiment, the alignment rods 4P, typically cylindrical rods, are arranged at the points of a square, forming a central aperture, or optic axis. Further, the brackets 6P for mounting optics are fixed at lengths along the rods 4P. The mounting brackets 6P feature a central aperture 8P for mounting optics within the rods 4P. Cage assemblies provide mounts 9P such as threaded holes for receiving support posts or pedestals which extend either parallel or perpendicular to the planes shared by the axes of adjacent rods.

It should be noted that two rods 4P can be removed to allow for improved access to the optical path at the expense of stability. In one of the side views of FIG. 1P, only the bottom two rods 4P are utilized to provide access to the optical path. In this arrangement, the top two rods 4P are have been removed. With this arrangement, the remaining two rods 4P can be bent relatively easily as illustrated with arrow 11P as a result of gravity. In the other one of the side views of FIG. 1P, the two rods 4P on only one side of the optical path are utilized. With this arrangement, the remaining two rods 4P can still be bent as illustrated with arrow 11P as a result of gravity, but not as much as the previous arrangement. However, this subsequent arrangement is more susceptible to bending into and out of the page.

The cage assembly incorporates a native means of introducing beam bends via (i.e. joining cubes) as well as translation (i.e. along the rods). Unfortunately, with the optical mounting brackets in the prior art, it is somewhat difficult to insert and remove optical components without disturbing the other optical components in the assembly due to the interposition of the rods. In such designs, compactness has been achieved at the expense of convenient access to the optical path. Further, mounting brackets in the prior art are only suited to mount optical components within a relatively small range of shape and size.

### SUMMARY

The present invention is directed to a mounting assembly for mounting an optical component along an optical axis to an apparatus frame of a precision apparatus. The precision apparatus includes a first mechanical alignment rod, a second alignment rod and a third alignment rod that extend parallel to the optical axis. The mounting assembly includes a mounting bracket having (i) a first component mount for retaining the optical component, (ii) a first rod aperture that receives the first alignment rod and a first rod lock that selectively locks the first alignment rod to the mounting bracket, (iii) a second rod aperture that receives the second alignment rod and a second rod lock that selectively locks the second alignment rod to the mounting bracket, and (iv) a third rod aperture that receives the third alignment rod and a third rod lock that selectively locks the third alignment rod to the mounting bracket. In one embodiment, the rod apertures are spaced apart in a fashion to form the corners of an obtuse triangle. With this design, the mounting bracket securely retains the optical component while providing unobstructed access to the optical axes for the easy and at will in terms of positioning and arrangement, insertion and removal of the optical components. This allows for the relatively easy arrangement, assembly, modification, and/or repair of the precision apparatus.

In one embodiment, the mounting bracket does not encircle the optical axis. Further, the mounting bracket can include a generally flat first surface, and the first component mount can be positioned near and perpendicular to the generally flat first surface. Moreover, the mounting bracket can include a generally flat second surface that is perpendicular to the first surface, and a second component mount that is positioned near and perpendicular to the generally flat second surface. In this embodiment, the first component mount has a first mount axis, the second component mount has a second mount axis, and the mount axes intersect at the optical axis.

Additionally, the mounting bracket can include a fourth rod aperture that receives a fourth alignment rod and a fourth rod lock that selectively locks the fourth alignment rod to the mounting bracket. In this embodiment, the rod apertures are spaced apart in a fashion to form the corners of a trapezoid. Further, the rod apertures can be positioned on a same side of the optical axis.

In another embodiment, the rod apertures are positioned in a fashion so that a line between the rod apertures is approximately diagonal to the first axis, and both rod apertures are positioned on a same side of the first mount axis.

Moreover, the present invention is also directed to a precision apparatus that includes an apparatus frame, an optical component, a first alignment rod, a second alignment rod, a third alignment rod, and one or more of the mounting brackets disclosed herein.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1P illustrates a front view of a prior art cage assembly and two side views of alternative cage assemblies;

FIG. 1 is a simplified perspective illustration of a portion of a precision apparatus having features of the present invention;

FIGS. 2A, 2B, 2C and 2D are alternative views of one embodiment of a mounting bracket having features of the present invention;

FIGS. 3A, 3B, 3C and 3D are alternative views of another embodiment of a mounting bracket having features of the present invention;

FIG. 4 is a perspective view of portion of another embodiment of the precision assembly;

FIG. 5 is a perspective view of portion of yet another embodiment of the precision assembly;

FIG. 6 is a perspective view of portion of still another embodiment of the precision assembly;

FIG. 7 is a perspective view of portion of another embodiment of the precision assembly;

FIG. 8A is a front plan view, FIG. 8B is a top view, and FIG. 8C is a perspective view of another embodiment of a mounting bracket having features of the present invention;

FIG. 9 is a perspective view of portion of yet another embodiment of the precision assembly; and

FIG. 10 is a perspective view of portion of still another embodiment of the precision assembly.

### DESCRIPTION

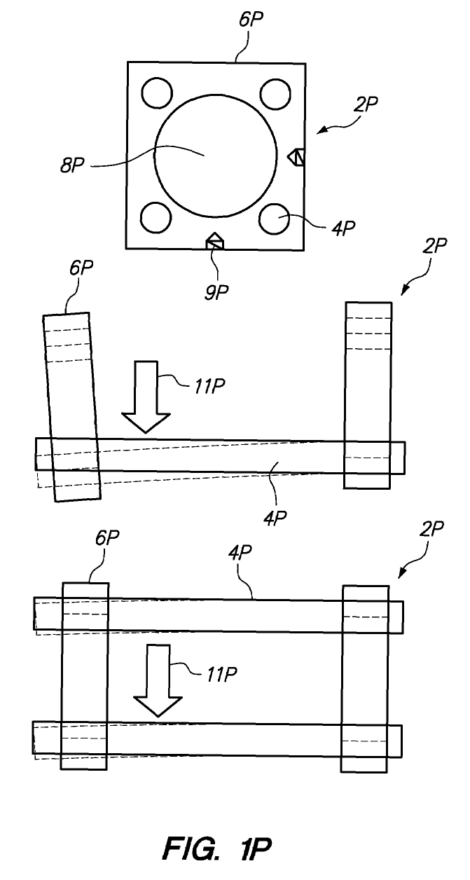

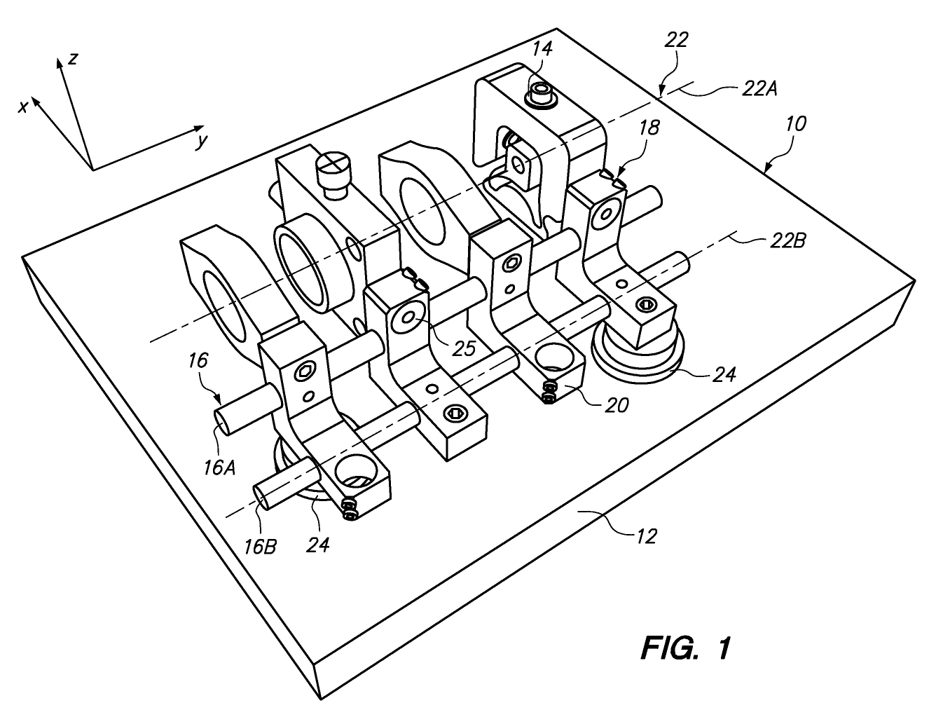

Referring to FIG. 1, the present invention is directed to a precision apparatus 10 that, for example, can be used in manufacturing, technical or scientific instruments. Applications include the collimation of light sources such as fibers, LED's or lasers, focusing of light into fibers, spectroscopic instruments, telescopic beam expanders/reducers, spatial filters, and inspection systems such as telescopes, microscopes, especially for custom designs and prototypes.

The design and orientation of the components of the precision apparatus 10 can be changed to suit the requirements of the precision apparatus 10. FIG. 1 is a simplified top perspective view of one embodiment of the precision apparatus 10. In this embodiment, the precision apparatus 10 includes an apparatus frame 12 (e.g. an optical table), a plurality of optical components 14, a plurality of mechanical alignment structures here-in referred to as alignment rods 16, and a mounting assembly 18 (e.g. cage plate and support base) that is useful for securing the optical components 14 to the apparatus frame 12.

As an overview, in certain embodiments, the mounting assembly 18 includes one or more mounting brackets 20 that are uniquely designed to selectively and fixedly retain various optical components 14 along one or more optical axes 22 (illustrated with dashed lines), while providing unobstructed access to the optical axes 22 for the easy and at-will positioning and arrangement, insertion and removal of the optical components 14. This allows for the relatively easy arrangement, assembly, modification, and/or repair of the precision apparatus 10. Moreover, the mounting bracket 20 enables easy in-plane and out-of-plane bends in the optical axis 22 via rotation of the supported optical element 14.

As described in more detail below, the present invention uses uniquely designed mounting brackets 20 that allow for a wider, flatter arrangement of the alignment rods 16 to enable an open-cage layout of the mounting assembly 18. As provided herein, one or more of the mounting brackets 20 do not encircle the optical axis 22. Further, one or more of the mounting brackets 20 can have a somewhat “L” or a somewhat “C” shaped configuration that provides significant access to the optical axis 22. The novel configurations described herein offer greatly improved access to the optical path for insertion and removal of optical elements, including more optics of varied size and shape, as well as diagnostic tool, thus achieving a significant improvement in the state of the art over prior cage assemblies.

It should be noted that many of the Figures include an orientation system that illustrates an X axis, a Y axis that is orthogonal to the X axis, and a Z axis that is orthogonal to the X and Y axes. It should be noted that these axes can also be referred to as the first, second, and third axes.

The apparatus frame 12 retains and/or supports the other components of the precision apparatus 10. In one embodiment, the apparatus frame 12 is generally rectangular plate shaped and is made of a rigid material. For example, the apparatus frame 12 can be a breadboard or an optical table.

The type of optical components 14 used in the precision apparatus 10 can be varied according to the requirements of the precision apparatus 10. Non-exclusive examples of optical components 14 include optical filters, polarizers, lens, mirrors, emitters, sensors, detectors, prisms, filter wheels, light sources, beam steerers, diagnostic elements, beamsplitters, diagnostic tools (e.g. fluorescent cards, power meters, alignment rods, beam profilers, detectors and cameras), or another type of optical component. As mentioned above, with the mounting brackets 20 provided herein, the optical components 14 can be easily added, removed, adjusted or repaired. Some of the optical components 14 can include a post 25 that can be engaged by the mounting brackets 20.

In FIG. 1, the precision apparatus 10 takes light out of an optical fiber and filters the beam to get a Gaussian spatial profile. The optical components from right to left in FIG. 1 are: (18) an XZ (2D) fiber chuck positioner for launching light out of the end of an optical fiber (14) to a fixed lens which focuses the light onto a pinhole in an XYZ (3D) adjuster. The last lens is a collimating lens which takes the divergent light emerging from the pinhole mounted inside the XYZ positioner and collimates it into a nicely shaped beam. The optics in (18) and (25) are mounted on (screwed into) 0.5″ diameter×0.5″ length support posts (rods) which are clamped from the side by two set screws. The optics in (14) and the leftmost mount are secured by socket cap screws in counterbored holes. The mounts are tapped to receive the screws. It should be noted that only one type of mounting bracket 20 is illustrated in FIG. 1. However, the mounting bracket 20 is illustrated in to different orientations. In this embodiment, one side of the mounting brackets 20 is mounted with a screw and another one of the mounting brackets 20 receives a post.

The alignment rods 16 align and interconnect the one or more mounting brackets 20 used in the precision apparatus 10. The number of alignment rods 16 used in the precision apparatus 10 can vary according to the design of the mounting brackets 20 used in the precision apparatus 10. In FIG. 1, the precision apparatus 10 includes a first alignment rod 16A and a second alignment rod 16B that are spaced apart and that extend parallel to each other along the Y axis. In this embodiment, the two alignment rods 16A, 16B are uniquely oriented to provide good rigidity to the downward force of gravity because the alignment rods 16 are oriented at 45 degrees relative to the mounting brackets 20 and the apparatus frame 12. This presents a similarly large bending moment to most ubiquitous source of torque under 90 degree rotations about the Y axis.

Further, the use of only two alignment rods 16 provides great flexibility in mounting of optical components 14 of various sizes and shapes along the optical axes 22A, 22B.

The size, shape, and length of the alignment rods 16 can be varied to achieve the design requirements of the precision apparatus 10. In one non-exclusive embodiment, each alignment rod 16 is a generally circular shaped rod having an outer diameter of approximately 0.3 inches (8 mm), and a length of between approximately 3 and 12 inches. Alternatively, for example, one or more of the alignment rods 16 can have a generally rectangular shaped cross-section, and a length greater or lesser than that described above. The alignment rods 16 can be made of any rigid material. Suitable materials include, for instance, steel, a composite, a hard plastic, or aluminum.

In FIG. 1, the alignment rods 16 extend substantially parallel with one or more optical axes 22 of the precision apparatus 10 and maintain the optical components 14 along the optical axes 22. In FIG. 1, the precision apparatus 10 has a first optical axis 22A that is positioned outside the mounting brackets 20. In this embodiment, the optical components 14 are aligned along the first optical axis 22A. Additionally, the mounting brackets 20 can include a second optical axis 22B that is above the mounting brackets 20.

The one or more mounting brackets 20 secure the optical components 14 to the apparatus frame 12. The number of mounting brackets 20 secured to the alignment rods 16 can vary. In the non-exclusive example illustrated in FIG. 1, the mounting assembly 18 includes four mounting brackets 20. Alternatively, the mounting assembly 18 can include more than four or fewer than four mounting brackets 20.

Additionally, in this embodiment, the mounting assembly 18 includes one or more bracket attachers 24 that attach the brackets 20 to the apparatus frame 12. In FIG. 1, the mounting assembly 18 includes two bracket attachers 24. The design of the bracket attachers 24 can vary. For example, one or more of the bracket attachers 24 can be a fixed riser pedestal, as shown, or a common post, post holder and base assembly. Bracket attachers 24 can be fixed to the apparatus frame 12 with, for instance, a suitable clamping fork, magnet or screw.

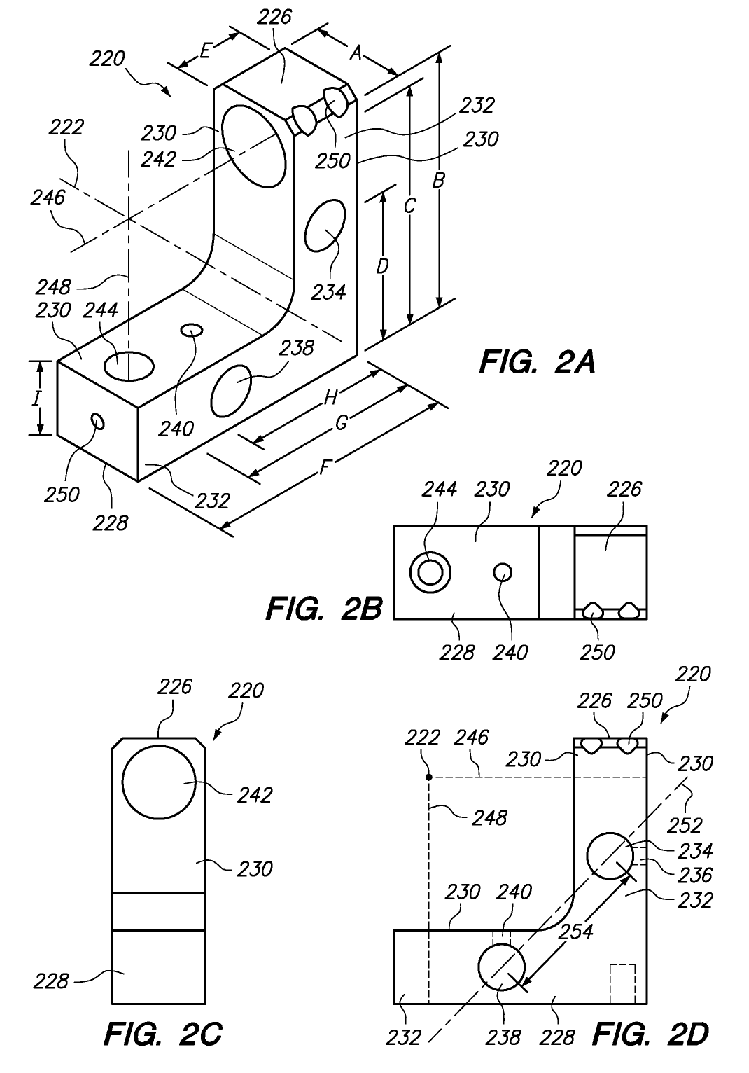

FIGS. 2A, 2B, 2C and 2D are alternative views of one embodiment of a mounting bracket 220 having features of the present invention. In this embodiment the mounting bracket 220 is generally rectangular “L” shaped and includes a generally rectangular shaped first segment 226 and a generally rectangular shaped second segment 228 that is oriented substantially perpendicular to the first segment 226. A mounting bracket 220 with the configuration illustrated in FIGS. 2A-2D shall be referred to herein as a “L mounting bracket”. In this embodiment, each segment 226, 228 includes first pair of opposed, generally flat mounting surfaces 230 and a second pair of opposed generally flat side surfaces 232 (front and rear faces).

In this embodiment, the mounting bracket 220 includes (i) a first rod aperture 234 that freely receives one of the alignment rods 16 (illustrated in FIG. 1), (ii) a first rod lock 236 that selectively locks one of the alignment rods 16A to the mounting bracket 220, (iii) a second rod aperture 238 that freely and slidably receives another one of the second alignment rods 16, and (iv) a second rod lock 240 that selectively locks that alignment rod 16 to the mounting bracket 220. In this embodiment, each of the rod apertures 234, 238 has a size and shape that corresponds to the size and shape of the alignment rods 16. For example, in this embodiment each of the rod apertures 234, 238 is a circular aperture that extends between the side surfaces 232 having a diameter that is slightly greater to that of the alignment rods 16. Further, in this embodiment, each of the rod locks 236, 240 includes a set screw that threads into an internally threaded surface in the mounting bracket 220. In this embodiment, rotation of the set screw in one direction causes the set screw to engage (and lock) the alignment rod 1 6 in the respective rod aperture 234, 238, while rotation of the set screw in the opposite direction causes the set screw to disengage (and unlock) the alignment rod 16 in the respective rod aperture 234, 238. Alternatively, each of the rod locks 236, 238 can have a design that is different than that illustrated in these Figures. In the L mounting bracket 220, the first rod aperture 234 and the first rod lock 236 are positioned in the first segment 226 and the second rod aperture 238 and the second rod lock 240 are positioned in the second segment 228.

Additionally, the mounting bracket 220 can include a first component mount 242 and a spaced apart second component mount 244 that can each used to attach optical components 14 (illustrated in FIG. 1) to the mounting bracket 220. In one embodiment, the first component mount 242 is located in the first segment 226 and the second component mount 228 is located in the second segment 228. Further, the first component mount 242 extends along a first mount axis 246 that extends perpendicular to the flat surfaces 230 of the first segment 226, and the second component mount 244 extends along a second mount axis 248 that extends perpendicular to the flat surfaces 230 of the second segment 228. Further, in this embodiment, the mount axes 246, 248 intersect on the optical axis 222. This facilitates easy mounting of the optical components 14 along the optical axis 222 from two different locations.

The design of each component mount 242, 244 can vary. In one embodiment the first component mount 242 is a counterbored thru hole, and the second component mount 244 is a double bore through hole. For example, the first component mount 242 can be a 5/16 inch aperture, and the second component mount 244 can include a thru hole counterbored on both sides for receiving a #8 size socket cap screw fastener. Additionally, one or both component mounts 242, 244 can include a mount lock 250 that selectively locks the optical component 14 to the mounting bracket 220. For example, each mount lock 250 can include one or more set screws. With this design, the component mounts 242, 244 can receive a cylindrical shaped post 25 (illustrated in FIG. 1) that allows the mounting bracket 220 to support optical components 14 either “inside” or “outside” of the alignment rods 16. An alternative variation could, for instance, implement a threaded hole, alignment pin or dovetail guide for a mount.

It should be noted that in FIGS. 2A-2D, the rod apertures 234, 238 are spaced apart and oriented in a fashion so that a line 252 (illustrated as a dashed line illustrated in FIG. 2D) between the rod apertures 234, 238 is approximately diagonal (approximately 45 degrees) to the first mount axis 246, the second mount axis 248, the flat surfaces 230 of the first segment 226, and the flat surfaces 230 of the second segment 228. Further, the rod apertures 234, 238 are positioned on a same side of the first mount axis 246, the second mount axis 248 and the optical axis 222. In this embodiment, the two rod apertures 234, 236 are uniquely oriented at 45 degrees to the mounting brackets 220 to allow the alignment rods 16 to provide good rigidity to the downward force of gravity in a variety of mounting configurations derived from 90 degree rotations about the optical axis.

The dimensions of the mounting bracket 220 can be varied to achieve the design requirements of the mounting assembly 18. Referring to FIG. 2A, one non-exclusive example of suitable dimensions for the mounting bracket 220 includes (i) A=0.5 inches, (ii) B=1.875 inches, (iii) C=1.5 inches, (iv) D=1 inch, (v) E=0.5 inches, (vi) F=1.75 inches, (vii) G=1.5 inches, (viii) H=1 inch, and (ix) I=0.5 inches. It should be noted that these dimensions are only provided for reference and that the mounting bracket 220 can have measurements different than provided above.

Additionally, in one non-exclusive embodiment, a separation distance 254 between the centers of adjacent rod apertures 234, 236 is approximately one inch.

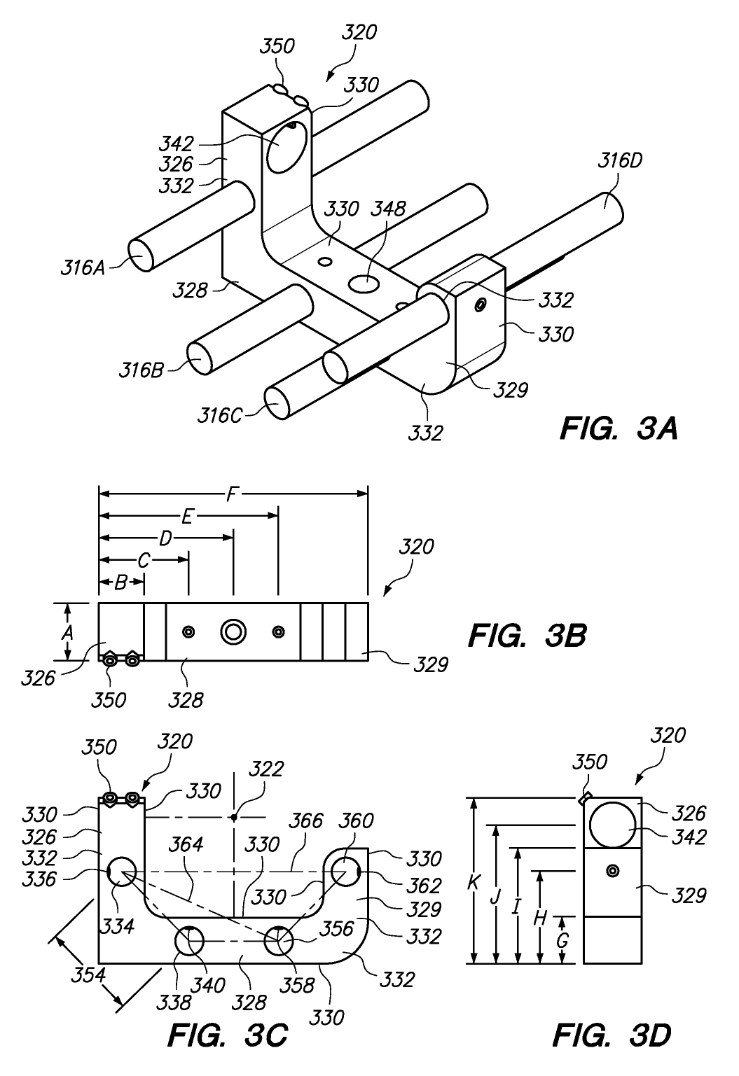

FIGS. 3A, 3B, 3C and 3D are alternative views of another embodiment of a mounting bracket 320 having features of the present invention. FIG. 3A also illustrates that in this embodiment, the mounting bracket 320 is capable of receiving a first alignment rod 316A, a second alignment rod 316B, a third alignment rod 316C, and a fourth alignment rod 316D.

In this embodiment the mounting bracket 320 is generally rectangular, “C” shaped and includes a generally rectangular shaped first segment 326, a generally rectangular shaped second segment 328 that is oriented substantially perpendicular to the first segment 326, and a generally rectangular shaped third segment 328 that is oriented substantially parallel to the first segment 326 and perpendicular to the second segment 328. A mounting bracket 320 with the configuration illustrated in FIGS. 3A-3D shall be referred to herein as a “C mounting bracket”. In this embodiment, each of the segments 326, 328, 329 includes first pair of opposed, generally flat surfaces 330, and a second pair of opposed generally flat side surfaces 332.

In this embodiment, the mounting bracket 320 includes (i) a first rod aperture 334 that freely and slidably receives the first alignment rod 316A, (ii) a first rod lock 336 that selectively locks the first alignment rod 316A to the mounting bracket 320, (iii) a second rod aperture 338 that freely and slidably receives the second alignment rod 316B, (iv) a second rod lock 340 that selectively locks the second alignment rod 316B to the mounting bracket 320, (v) a third rod aperture 356 that freely and slidably receives the third first alignment rod 316C, (vi) a third rod lock 358 that selectively locks the third alignment rod 316C to the mounting bracket 320, (vii) a fourth rod aperture 460 that freely and slidably receives the fourth alignment rod 416B, and (viii) a fourth rod lock 362 that selectively locks the fourth alignment rod 316D to the mounting bracket 320 In this embodiment, each of the rod apertures 334, 338, 356, 360 has a size and shape that corresponds to the size and shape of the alignment rods 316A-316D. For example, in this embodiment, each of the rod apertures 334, 338, 356, 360 is a circular bore that extends between the side surfaces 332 that has a diameter that is slightly greater to that of the alignment rods 316A-316D.

Further, in this embodiment, each of the rod locks 336, 340, 358, 362 includes a set screw that threads into an internally threaded surface in the mounting bracket 320. In this embodiment, rotation of the set screw in one direction causes the set screw to engage (and lock) the respective alignment rod 316A-316D in the respective rod aperture 334, 338, 356, 360, while rotation of the set screw in the opposite direction causes the set screw to disengage (and unlock) the alignment rod 316A-316D in the respective rod aperture 334, 338, 356, 360. Alternatively, each of the rod locks 336, 340, 358, 362 can have a design that is different than that illustrated in these Figures. In this embodiment, (i) the first rod aperture 334 and the first rod lock 336 are positioned in the first segment 326, (ii) the second and third rod apertures 338, 356, and the second and third rod locks 340, 358 are positioned in the second segment 328, and (iii) the fourth rod aperture 360 and the fourth rod lock 362 are positioned in the third segment 329.

Additionally, the mounting bracket 320 can include a first component mount 342 and a spaced-apart second component mount 344 that can each used to attach optical components 14 (illustrated in FIG. 1) to the mounting bracket 320. In one embodiment, the first component mount 342 is located in the first segment 326 and the second component mount 328 is located in the second segment 328. Further, the first component mount 342 extends along a first mount axis 346 that extends perpendicular to the flat surfaces 330 of the first segment 326, and the second component mount 344 extends along a second mount axis 348 that extends perpendicular to the flat surfaces 330 of the second segment 328. Further, in this embodiment, the mount axes 346, 348 intersect on the optical axis 322. This facilitates easy mounting of the optical components 14 (illustrated in FIG. 1) along the optical axis 322 from two different locations.

The design of each component mount 342, 344 can vary. In one embodiment, the first component mount 342 is a counterbored thru hole, and the second component mount 344 is a double bore through hole. For example, the first component mount 342 can be a ½ inch aperture, and the second component mount 344 can include a thru hole counterbored on both sides for receiving a #8 size socket cap screw fastener. Additionally, one or both component mounts 342, 344 can include a mount lock 350 that selectively locks the optical component 14 to the mounting bracket 320. For example, each mount lock 350 can include one or more set screws. With this design, the component mounts 342, 344 can receive a post 25 (illustrated in FIG. 1) that allows the mounting bracket 320 to support optical components 14 either “inside” or “outside” of the alignment rods 316A-316D.

It should be noted that in FIGS. 3A-3D, the rod apertures 334, 338, 356, 360 are spaced apart and oriented in a fashion so that centers of any three of the four rod apertures 334, 338, 356, 360 form the corners of an obtuse triangle 364 (illustrated with dashed lines). Further, the rod apertures 334, 338, 356, 360 are spaced apart and oriented in a fashion so that centers of the four rod apertures 334, 338, 356, 360 form the corners of a trapezoid (illustrated with dashed lines. Further, in this embodiment, the rod apertures 334, 338, 356, 360 are all positioned one the same side (e.g. below) the first mount axis 346 and the optical axis 322.

With this design, the alignment rods 316A-316D are moved outward and downward (wider and flatter “U” arrangement) to open the space near the optical axis 322 for the insertion and removal of optical components 14. Stated in another fashion, the non-square, asymmetric, open arrangement of the four alignment rods 316A-316D provides improved access to optic path enabling at will in terms of positioning and arrangement insertion/removal of optical components 14.

Moreover, because of this arrangement of the alignment rods 316A-316D, the alignment rods 316A-316D may be rotated into a taller, narrower “C” arrangement, so as to present a much stronger bending moment to gravitation torque than if the alignment rods 316A-316D were oriented in a square pattern.

Additionally, in one non-exclusive embodiment, a separation distance 354 between the centers of adjacent rod apertures 334, 338, 356, 360 is approximately 1 inch. With this design, as illustrated in subsequent Figures, the C mounting bracket 320 and the L mounting bracket 220 can be used on the same alignment rods 316A-316D.

The dimensions of the mounting bracket 320 can be varied to achieve the design requirements of the mounting assembly 18. Referring to FIGS. 3B and 3D, one non-exclusive example of suitable dimensions for the mounting bracket 320 includes (i) A=0.5 inches, (ii) B=0.5 inches, (iii) C=1 inch, (iv) D=1.5 inches, (v) E=2 inches, (vi) F=3 inches, (vii) G=0.5 inches, (viii) H=1 inch, (ix) I=1.25 inches, (x) J=1.5 inches, and (xi) K=1.875 inches. It should be noted that these dimensions are only provided for reference and that the mounting bracket 320 can have measurements different than provided above.

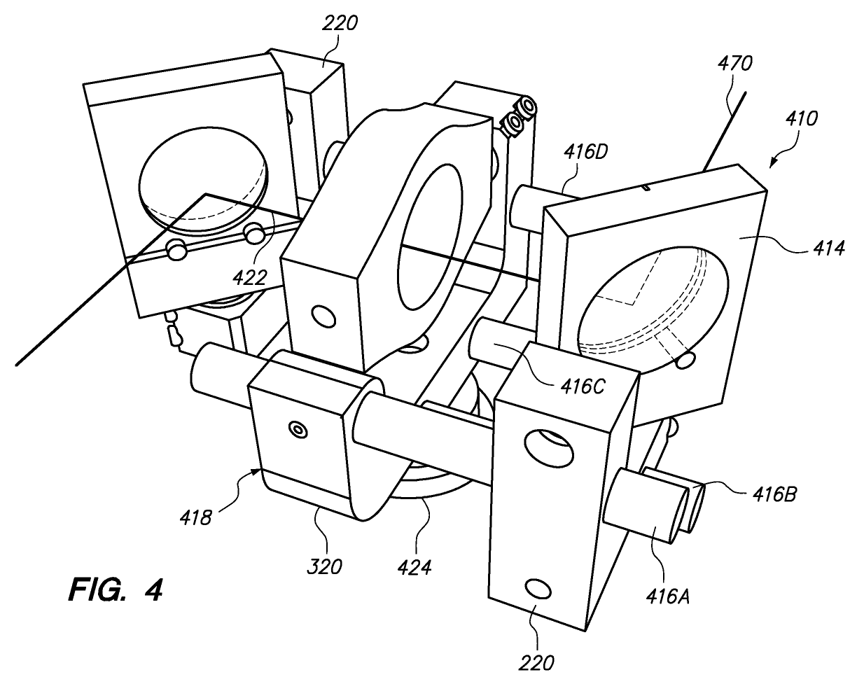

FIG. 4 is a perspective view of portion of another embodiment of the precision assembly 410. In this embodiment, the precision assembly 410 includes four alignment rods 416A-416D, three optical components 414, and one C mounting bracket 320 and two L mounting brackets 220. In this embodiment, the first, second, third and fourth alignment rods 416A-416D extend through the “C” shaped mounting bracket 320. Further, the C mounting bracket 320 is secured to the apparatus frame 12 (not shown in FIG. 4) with a bracket attacher 424. Further, one L mounting bracket 320 is retained by the first and second alignment rods 416A, 416B and the second L mounting bracket 320 is retained by the third and fourth alignment rods 416C, 416D. Further, each mounting bracket 220, 320 retains one optical component 414.

FIG. 4 illustrates that versatility of the mounting assembly 418 and how the optical components 414 can be retained and positioned to direct a beam 470 away from the optical axis 422. Stated in another fashion, the C mounting bracket 320 joins two alignment rod assemblies 416A,B and 416C,D to enable easy in-plane and out-of-plane bends in the beam 470 away from the optical axis 422 into at least two orthogonal planes intersecting the optical axis 422. Further, the C and L mounting brackets 220, 320 provide full access to the optical path for at will insertion and removal of the optical components 414.

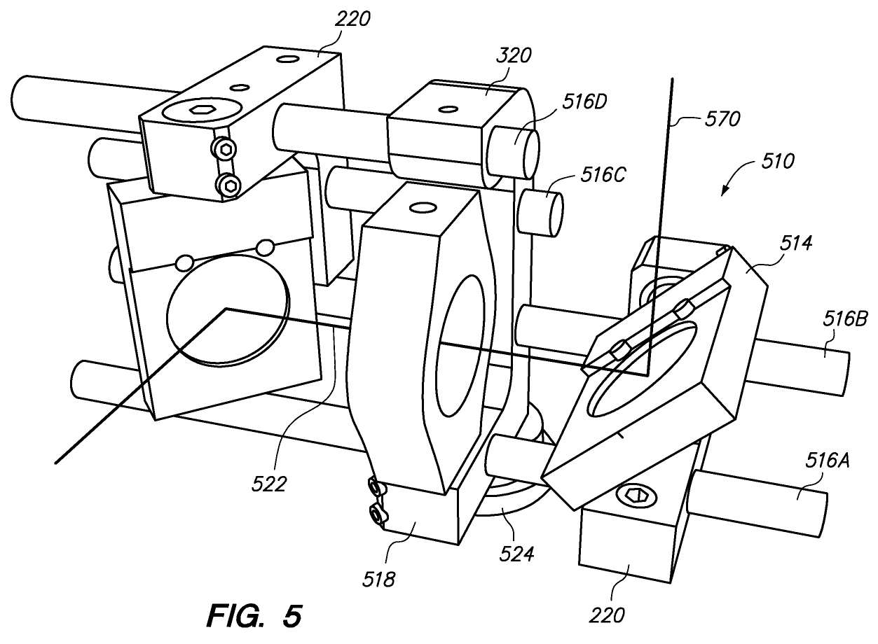

FIG. 5 is a perspective view of portion of yet another embodiment of the precision assembly 510 that is similar to the precision assembly 410 illustrated in FIG. 4. In this embodiment, the precision assembly 510 includes four alignment rods 516A-516D, three optical components 514, and one C mounting brackets 320 and two L mounting brackets 220. In this embodiment, the first, second, third and fourth alignment rods 516A-516D again extend through the “C” shaped mounting bracket 320. Further, the C mounting bracket 320 is secured to the apparatus frame 12 (not shown in FIG. 5) with a bracket attacher 524. Further, one L mounting bracket 320 is retained by the first and second alignment rods 516A, 516B and the second L mounting bracket 320 is retained by the third and fourth alignment rods 516C, 516D. Further, each mounting bracket 220, 320 retains one optical component 514.

FIG. 5 illustrates that versatility of the mounting assembly 518 and how the optical components 514 can be retained and positioned to direct a beam 570 away from the optical axis 522. Stated in another fashion, the C mounting bracket 320 joins two alignment rod assemblies 516A,B and 516C,D to enable easy in-plane and out-of-plane bends in the beam 570. Further, the C and L mounting brackets 220, 320 provide full access to the optical path for at will insertion and removal of the optical components 514.

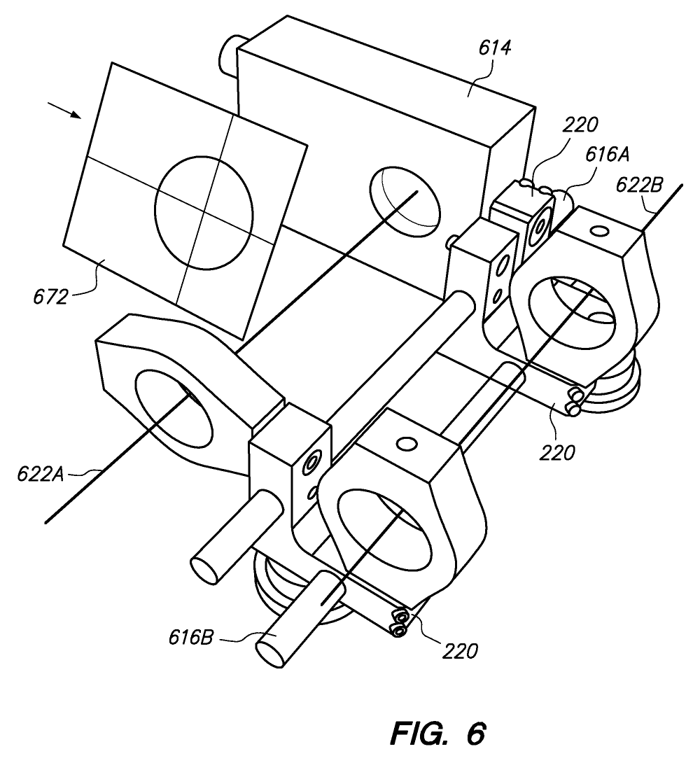

FIG. 6 is a perspective view of portion of another embodiment of the precision assembly 610. In this embodiment, the precision assembly 610 includes two alignment rods 616A-616B, four optical components 614, and three L mounting brackets 220. In this embodiment, the first and second alignment rods 616A-616B extend through the three L mounting brackets 220. Further, the L mounting brackets 220 are secured to the apparatus frame 12 (not shown in FIG. 6) with two bracket attacher 624.

FIG. 6 further illustrates that versatility of the mounting brackets and how the optical components 614 can be retained and positioned along two separate and parallel optical axes 622A, 622B, with one optical axis 622A outside the L mounting brackets 220 and one optical axis 622B positioned above the L mounting brackets 220. Moreover, these mounting brackets 220 allow for the mounting relatively large optical components 614. Further, FIG. 6 also illustrates that with the present design, an additional optical components 672 can be easily inserted into optical axes 222A, 222B because of the easy access to these axes.

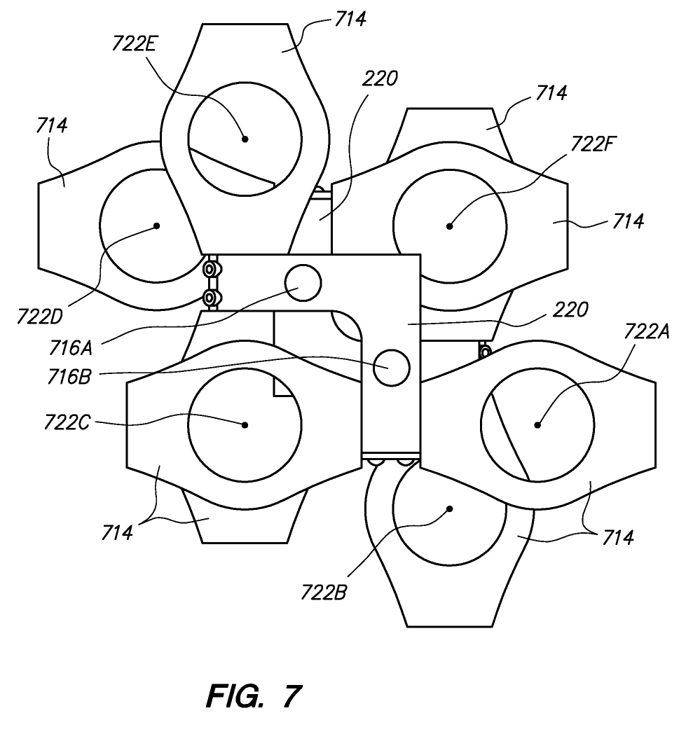

FIG. 7 is a front view of portion of another embodiment of the precision assembly 710. In this embodiment, the precision assembly 710 includes two alignment rods 716A-716B, eight optical components 714, and a plurality of L mounting brackets 220. In this embodiment, the first and second alignment rods 76A-716B extend through the plurality of L mounting brackets 220.

FIG. 7 further illustrates that versatility of the mounting brackets 220 and how the “inside or out” design allows a single pair of alignment rods 716A-716B to support the L mounting brackets 220 in four different orientations. This provides access to six unique optical axes 722A-722F from the same type of mounting bracket 220.

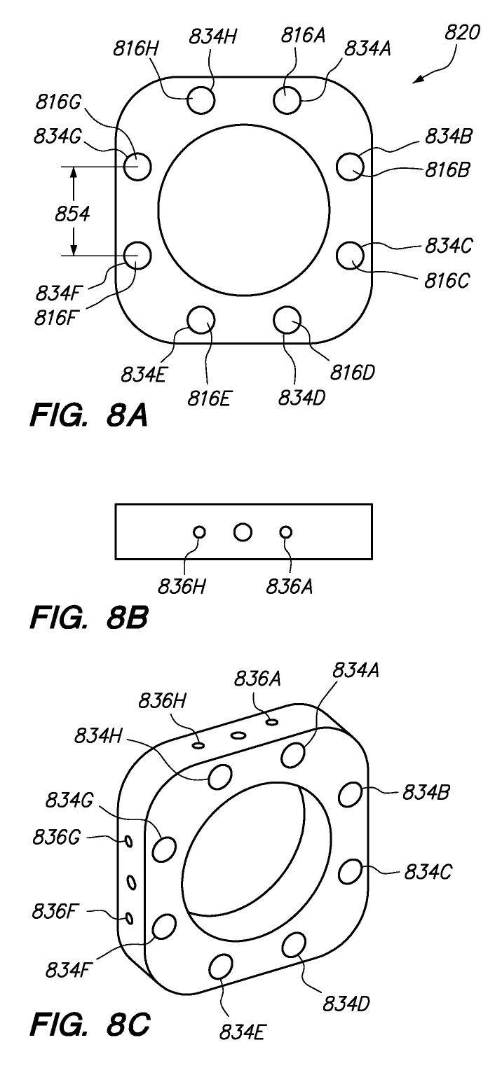

FIG. 8A is a front plan view, FIG. 8B is a top view, and FIG. 8C is a perspective view of another embodiment of a mounting bracket 820 and eight alignment rods 816A-816H (only shown in FIG. 8A) that extend through the mounting bracket 820. In this embodiment the mounting bracket 820 is generally “O” shaped. A mounting bracket 820 with the configuration illustrated in FIG. 8 shall be referred to herein as an “O mounting bracket”.

In this embodiment, the mounting bracket 820 includes eight rod apertures 834A-834H and each of the rod apertures 834A-834H includes a rod lock 836A, 836F, 836G, 836H (only four are illustrated) that selectively locks the respective alignment rod 816A-816H to the mounting bracket 820. The rod apertures 834A-834H and the rod locks 836A, 836F, 836G, 836H are similar to the corresponding components described above.

It should be noted that in this embodiment, the rod apertures 834A-834H are spaced apart and oriented in a fashion so that centers of any adjacent three of the rod apertures 834A-834H form the corners of an obtuse triangle (not shown in FIGS. 8A-8C). Further, the rod apertures 834A-834H are spaced apart and oriented in a fashion so that centers of any adjacent four rod apertures 834A-834H form the corners of a trapezoid (not shown in FIGS. 8A-8C). Moreover, the rod apertures 834A-834H are spaced apart and oriented in a fashion so that centers of the eight rod apertures 834A-834H form the corners of an octagon. It should be noted that is not an equilateral regular octagon. In the illustrated design, the diagonal spacing is greater than the lateral spacing.

Additionally, in one non-exclusive embodiment, a separation distance 854 between the centers of adjacent rod apertures 834A-834H is approximately 1 inch. With this design, as illustrated in subsequent Figures, the C mounting bracket 320 and the L mounting bracket 220 can be used on the same alignment rods 816A-816H. Moreover, with this design, the O mounting bracket 820 retains the alignment rods 816A-816H is a fashion that allows the C mounting bracket 320 (not shown in FIG. 8) and the L mounting bracket 220 (not shown in FIG. 8) to be retained in a plurality of alternative orientations.

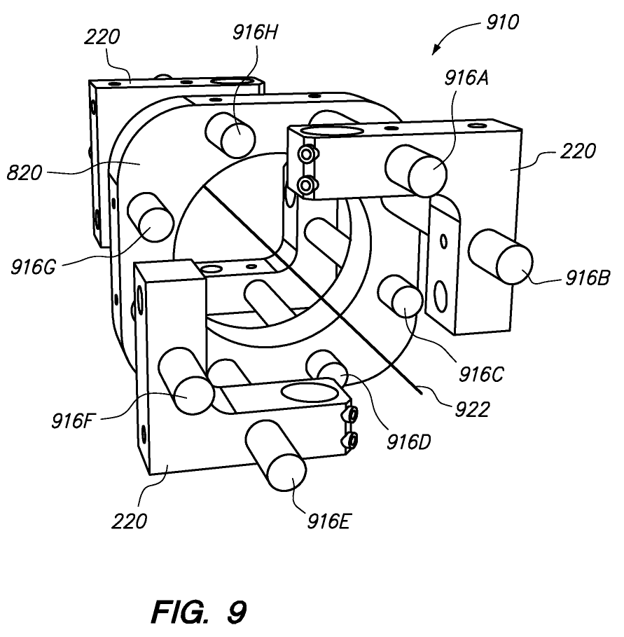

FIG. 9 is a perspective view of portion of another embodiment of the precision assembly 910. In this embodiment, the precision assembly 910 includes eight alignment rods 916A-916B, an O mounting bracket 820 that receives the eight alignment rods 916A-916B, and three L mounting brackets 220. In this embodiment, (i) the first and second alignment rods 916A-916B extend through and support one of the L mounting brackets 220, (ii) the fifth and sixth alignment rods 916E-916F extend through and support one of the L mounting brackets 220, and (iii) the seventh and eighth alignment rods 916G-916H extend through and support one of the L mounting brackets 220.

FIG. 9 further illustrates that versatility of the mounting brackets 220, 820 and how the L mounting brackets 220 can be arranged symmetrically around a circular pattern with a common optical axis 922. In this embodiment, the L mounting brackets 220 may face in any of four directions and can be joined and/or share the common optical axis 922.

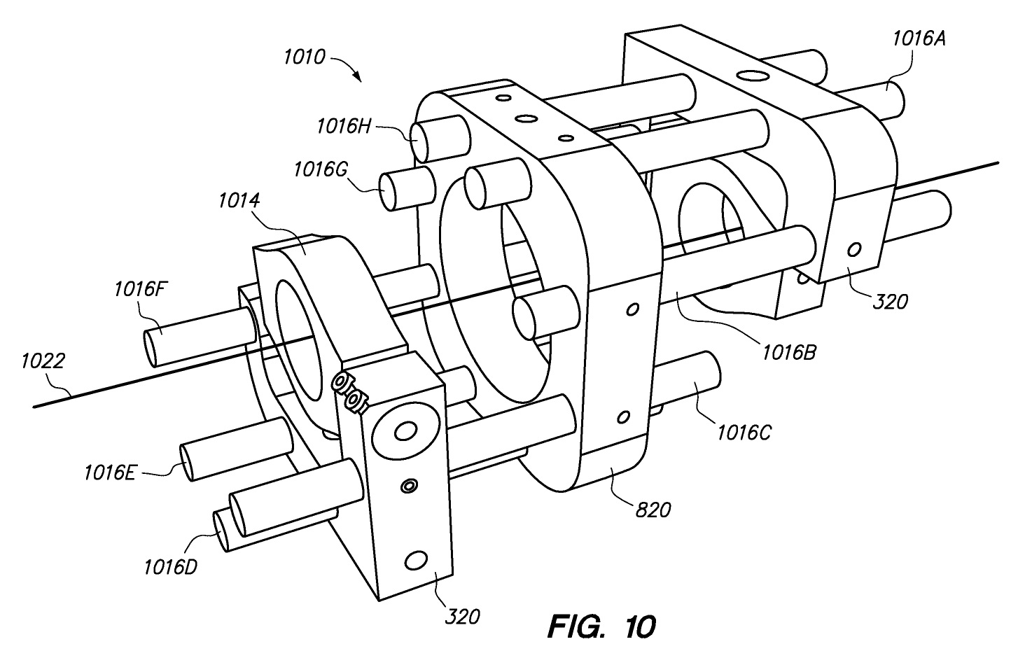

FIG. 10 is a perspective view of portion of another embodiment of the precision assembly 1010. In this embodiment, the precision assembly 1010 includes eight alignment rods 1016A-1016B, an O mounting bracket 820 that receives the eight alignment rods 1016A-1016B, and two C mounting brackets 320. In this embodiment, (i) the first, second, seventh and eighth alignment rods 1016A, 1016B, 1016G, 1016H extend through and support one of the C mounting brackets 320, and (ii) the third, fourth, fifth and sixth alignment rods 1016C, 1016D, 1016E, 1016F extend through and support one of the C mounting brackets 320. This allows independent sets of four-rod assemblies to be adjusted relative to one another along a common axis within a single mechanically rigid apparatus.

FIG. 10 further illustrates that versatility of the mounting brackets 320, 820 and how the C mounting brackets 320 can be arranged at many different locations symmetrically around a circular pattern with a common optical axis 1022.

With the present invention, various fractions of a complete enclosure, e.g. “O”, “C”, and/or “L” mounting brackets, can be used as needed to optimize for compactness or rigidity, as desired.

The unique “drop-in” and “inside or out” mounting capabilities of the mounting brackets disclosed herein allows for at will insertion and removal of optical components which are too large in include in traditional cage designs or for which a custom mount is not available. This maximizes economy by enabling users to make use of readily available post-mounting optomechanical compoments.

While the particular apparatus 10 as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A mounting assembly for mounting an optical component along an optical axis to an apparatus frame of a precision apparatus, the precision apparatus including a first alignment rod, a second alignment rod and a third alignment rod that extend parallel to the optical axis, the mounting assembly comprising:
a mounting bracket including (i) a first component mount for retaining the optical component, (ii) a first rod aperture that receives the first alignment rod and a first rod lock that selectively locks the first alignment rod to the mounting bracket, (iii) a second rod aperture that receives the second alignment rod and a second rod lock that selectively locks the second alignment rod to the mounting bracket, and (iv) a third rod aperture that receives the third alignment rod and a third rod lock that selectively locks the third alignment rod to the mounting bracket; wherein the rod apertures are spaced apart in a fashion to form the corners of an obtuse triangle.

2. The mounting assembly of claim 1 wherein the mounting bracket does not encircle the optical axis.

3. The mounting assembly of claim 1 wherein the mounting bracket includes a generally flat first surface, and wherein the first component mount is positioned near and perpendicular to the generally flat first surface.

4. The mounting assembly of claim 3 wherein the mounting bracket includes a generally flat second surface that is perpendicular to the first surface, and a second component mount that is positioned near and perpendicular to the generally flat second surface.

5. The mounting assembly of claim 4 wherein the first component mount has a first mount axis and the second component mount has a second mount axis, and wherein the mount axes intersect at the optical axis.

6. The mounting assembly of claim 1 wherein the mounting bracket includes a fourth rod aperture that receives a fourth alignment rod and a fourth rod lock that selectively locks the fourth alignment rod to the mounting bracket; and wherein the rod apertures are spaced apart in a fashion to form the corners of a trapezoid.

7. The mounting assembly of claim 1 wherein the mounting bracket is somewhat “C” shaped.

8. The mounting assembly of claim 1 wherein the rod apertures are positioned on a same side of the optical axis.

9. A precision apparatus comprising an apparatus frame, an optical component, a first alignment rod, a second alignment rod, a third alignment rod, and the mounting bracket of claim 1 securing the optical component to the apparatus frame.

10. A mounting assembly for mounting an optical component along an optical axis to an apparatus frame of a precision apparatus, the precision apparatus including a first alignment rod, and a second alignment rod that extend parallel to the optical axis, the mounting assembly comprising:
a mounting bracket including (i) a first component mount for retaining the optical component, the first component mount having a first mount axis, (ii) a first rod aperture that receives the first alignment rod and a first rod lock that selectively locks the first alignment rod to the mounting bracket, and (iii) a second rod aperture that receives the second alignment rod and a second rod lock that selectively locks the second alignment rod to the mounting bracket; wherein the rod apertures are positioned in a fashion so that a line between the rod apertures is approximately diagonal to the first axis; and wherein both rod apertures are positioned on a same side of the first mount axis.

11. The mounting assembly of claim 10 wherein the mounting bracket does not encircle the optical axis.

12. The mounting assembly of claim 10 wherein the mounting bracket includes a generally flat first surface, and wherein the first component mount is positioned near and perpendicular to the generally flat first surface.

13. The mounting assembly of claim 12 wherein the mounting bracket includes a generally flat second surface that is perpendicular to the first surface, and a second component mount that is positioned near and perpendicular to the generally flat second surface.

14. The mounting assembly of claim 13 wherein the first component mount has a first mount axis and the second component mount has a second mount axis, and wherein the mount axes intersect at the optical axis.

15. The mounting assembly of claim 10 wherein the mounting bracket includes (i) a third rod aperture that receives a third alignment rod, (ii) a third rod lock that selectively locks the third alignment rod to the mounting bracket, (iii) a fourth rod aperture that receives a fourth alignment rod, and (iv) a fourth rod lock that selectively locks the fourth alignment rod to the mounting bracket; and wherein the rod apertures are spaced apart in a fashion to form the corners of a trapezoid.

16. The mounting assembly of claim 10 wherein the mounting bracket is somewhat “L” shaped.

17. The mounting assembly of claim 10 wherein the rod apertures are positioned on a same side of the optical axis.

18. A precision apparatus comprising an apparatus frame, an optical component, a first alignment rod, a second alignment rod, and the mounting bracket of claim 10 securing the optical component to the apparatus frame.

19. A mounting assembly for mounting an optical component along an optical axis to an apparatus frame of a precision apparatus, the precision apparatus including a first alignment rod, and a second alignment rod that extend parallel to the optical axis, the mounting assembly comprising:
a mounting bracket including (i) a first rod aperture that receives the first alignment rod and a first rod lock that selectively locks the first alignment rod to the mounting bracket, (ii) a second rod aperture that receives the second alignment rod and a second rod lock that selectively locks the second alignment rod to the mounting bracket, (iii) a first component mount for retaining the optical component, the first component mount having a first mount axis, and (iv) a second component mount for retaining the optical component, the second component mount having a second mount axis; wherein the first mount axis is substantially perpendicular to the second mount axis, and wherein the mount axes intersect approximately at the optical axis.

20. The mounting assembly of claim 19 wherein the mounting bracket does not encircle the optical axis.

21. The mounting assembly of claim 19 wherein the mounting bracket includes a generally flat first surface, and wherein the first component mount is positioned near and perpendicular to the generally flat first surface.

22. The mounting assembly of claim 21 wherein the mounting bracket includes a generally flat second surface that is perpendicular to the first surface, and the second component mount that is positioned near and perpendicular to the generally flat second surface.

23. The mounting assembly of claim 19 wherein the mounting bracket includes (i) a third rod aperture that receives a third alignment rod, (ii) a third rod lock that selectively locks the third alignment rod to the mounting bracket, (iii) a fourth rod aperture that receives a fourth alignment rod, and (iv) a fourth rod lock that selectively locks the fourth alignment rod to the mounting bracket; and wherein the rod apertures are spaced apart in a fashion to form the corners of a trapezoid.

24. The mounting assembly of claim 19 wherein the mounting bracket is somewhat “L” shaped.

25. The mounting assembly of claim 19 wherein the mounting bracket is somewhat “U” shaped.

26. A precision apparatus comprising an apparatus frame, an optical component, a first alignment rod, a second alignment rod, and the mounting bracket of claim 19 securing the optical component to the apparatus frame.
